(19) United States
(12) Patent Application Publication
(10) Pub. No.: US 2012/0127544 A1
(43) Pub. Date: May 24, 2012

(54) IMAGE READING APPARATUS, IMAGE READING APPARATUS CONTROL METHOD, AND PROGRAM

(75) Inventor: Hiroyasu Morita, Yokohama-shi (JP)

(73) Assignee: CANON KABUSHIKI KAISHA, Tokyo (JP)

(21) Appl. No.: 13/300,371

(22) Filed: Nov. 18, 2011

(30) Foreign Application Priority Data
Nov. 24, 2010 (JP) 2010-261596

(51) Int. Cl. H04N 1/04

(52) U.S. Cl. 358/498; 358/474

(57) ABSTRACT

In an image reading apparatus, when a document is divided into a plurality of files and transmitted in conjunction with document reading, in order to store its transmission history, a division position of the obtained files is reflected and stored in the division position for inputting a page position divided in advance by a user. Consequently, a setting operation burden on the user can be reduced.

### BACKGROUND OF THE INVENTION

1. Field of the Invention

The present invention relates to an image reading apparatus, an image reading apparatus control method, and a program, for filing image data obtained by reading a document.

2. Description of the Related Art

Among conventional image reading apparatuses, for example, an image reading apparatus in which a document is read with a scanner, and the image data obtained by reading is filed is known. When filing image data with such an image reading apparatus, the image data can be converted into a designated file format using an image conversion function, and the converted image data can be formed into a single file or a plurality of files (hereinafter, referred to as “filing”).

For example, when filing image data formed from a plurality of pages obtained by reading a document having a plurality of pages with a scanner, each page of image data is respectively converted into image data in an appropriate file format designated by a user. At this stage, if the designated file format can have a plurality of pages in one file, all of the pages of the read document are formed together as one file.

Examples of file formats capable of having a plurality of pages in one file include Tag Image File Format (TIFF) and Portable Document Format (PDF).

However, in some cases the user may want to file the data by dividing a document having a plurality of pages at arbitrary pages and dividing into a plurality of files. Examples of a known method for dividing image data into a plurality of files in such a manner include the following.

Japanese Patent Application Laid-Open No. 2005-167938 discusses a method for dividing a file each time a document bundle is read by a scanner. In this method, the user pre-divides the document to be transmitted into a plurality of bundles that the user wants to divide the document into. Then, the user sets one of the plurality of bundles in an auto document feeder (ADF), for example.

A data transmission apparatus reads the set document bundle, and each time a bundle is read, the user resets a separate document bundle and issues a reading instruction. When all of the bundles have been read, the file is divided into each set bundle, and transmitted.

In Japanese Patent Application Laid-Open No. 2005-167938, the file is divided in conjunction with the document bundle set in the reading unit. Consequently, by dividing the document in advance into the bundles that the user wants to divide the document into as a file, the user does not have to check the correct number (number of pages) that acts as a file division unit.

However, after starting to read the document, each time the series of document reading operations acting as a division unit is finished, the user has to continuously instruct whether to read the next document by resetting the document in the reading unit or whether to finish reading. Consequently, in Japanese Patent Application Laid-Open No. 2005-167938, the user is forced to remain in front of the apparatus until the last document bundle is set.

When using the method discussed in Japanese Patent Application Laid-Open No. 2005-167938, the user may wish to store various reading settings as a history in the image reading apparatus, and, when performing the same processing for a second or subsequent time, to perform the same image reading processing by calling that history. In such a case, it is extremely troublesome for the user to be forced to remain in front of the apparatus until the last document bundle has been set just like when the processing was first performed, despite the fact that the processing is being performed by calling the history.

### SUMMARY OF THE INVENTION

The present invention is directed to an image reading apparatus capable of storing as a history a division position of a document when a plurality of files is generated from a document divided into a plurality of bundles, and of generating a file using the division position included in the stored history when reading a new document by calling that history.

According to an aspect of the present invention, an image reading apparatus includes a scan unit configured to obtain image data by reading a document, a generation unit configured to, based on the image data obtained by the scan unit reading each bundle of a document having a plurality of pages which is divided into a plurality of bundles, generate a plurality of files corresponding to each of the plurality of bundles, a first storage unit configured to store a division position for dividing the document into a plurality of bundles based on the reading of the document by the scan unit for each bundle, and a control unit configured to, when the document having a plurality of pages is read by the scan unit, control the generation unit to generate a plurality of files from the image data obtained by the scan unit reading the document having a plurality of pages based on the division position stored in the first storage unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration of a digital multifunction peripheral according to a first exemplary embodiment of the present invention.

FIG. 2 illustrates an example of an operation screen displayed on the operation unit illustrated in FIG. 1.

FIG. 3 illustrates an example of a division setting screen displayed on the operation unit illustrated in FIG. 1.

FIG. 4 is a flowchart illustrating a data transmission processing procedure in the digital multifunction peripheral illustrated in FIG. 1.

FIG. 5 illustrates an example of a confirmation screen displayed on the operation unit illustrated in FIG. 1 when executed in a reading conjunction mode.

FIG. 6 is a flowchart illustrating setting reception processing illustrated in FIG. 4 in detail.

FIG. 7 illustrates an example of a history call screen displayed when a history call button is pressed on the operation screen illustrated in FIG. 2.

FIG. 8 illustrates an example of an operation screen after a transmission history was called on the history call screen illustrated in FIG. 7.

### DESCRIPTION OF THE EMBODIMENTS

Various exemplary embodiments, features, and aspects of the invention will be described in detail below with reference to the drawings.

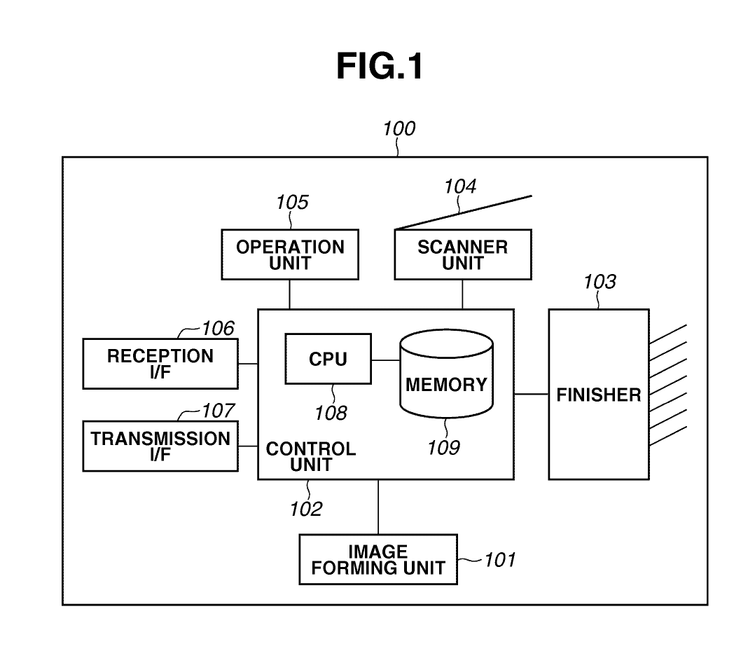

FIG. 1 is a block diagram illustrating a hardware configuration of a digital multifunction peripheral (copying machine) 100, which is an example of an image reading apparatus. The digital multifunction peripheral 100 has a plurality of functions, such as a copy function, a printer function, and data transmission and reception functions (including a facsimile function, an electronic mail function, and a file transfer function). The digital multifunction peripheral 100 includes a control unit 102. The control unit 102 is connected via an interface to an image forming unit 101, a finisher 103, a scanner unit 104, an operation unit 105, a reception interface 106, and a transmission interface 107.

The reception interface 106 and the transmission interface 107 correspond to the above plurality of data transmission and reception functions, and are in fact configured from a plurality of reception interfaces and transmission interfaces so as to correspond to the respective functions.

The control unit 102 has a central processing unit (CPU) 108 and a memory 109. The CPU 108 executes various processes and controls each of the above-described blocks based on programs stored in the memory 109.

The memory 109 includes programs for controlling so that images are filed and transmitted to an apparatus over a network.

The operation unit 105 includes an input panel (not illustrated) for inputting instructions to perform various settings, and a display panel (not illustrated) for displaying various setting information and messages. The instructions input by the operation unit 105 are input into the CPU 108 in the control unit 102.

In the present exemplary embodiment, when transmitting desired image data by the data transmission function, first, a transmission destination, a file type of the image data to be transmitted, and a transmission protocol are set on an operation screen in the operation unit 105. Next, the data transmission function is executed by instructing the scanner unit 104 to read the document.

The scanner unit 104 includes a reading mechanism for reading a document having a plurality of pages fed by a sheet feeding mechanism, such as an auto document feeder (ADF), and a reading mechanism for reading a single page document that is placed on a platen. When reading a document fed from the ADF, the document can be read by setting at a time the bundles of the document having a plurality of pages. When reading a document placed on the platen glass, a single page document is read at a time.

Image data generated from the read document is input into the control unit 102 and subjected to image processing. In the present exemplary embodiment, an example will be described in which image data generated by reading a document having a plurality of pages fed from the ADF is transmitted.

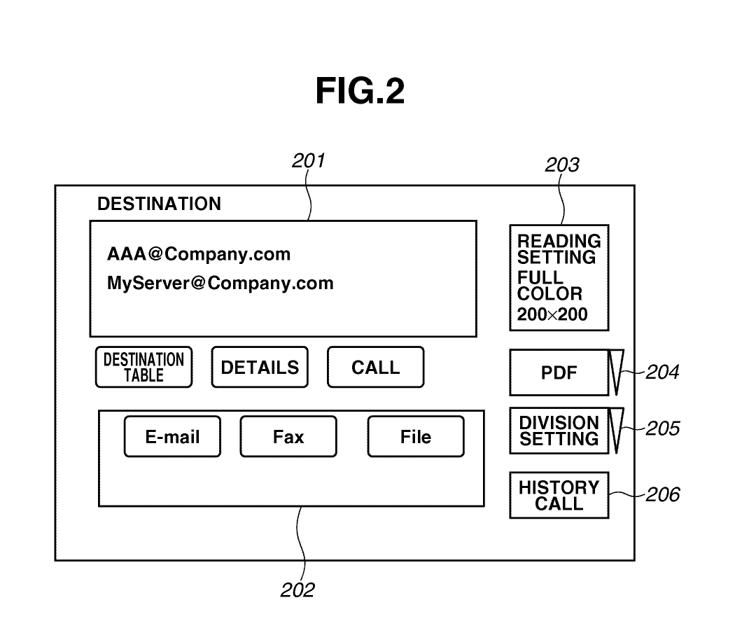

FIG. 2 illustrates an example of an operation screen displayed on the operation unit 105 illustrated in FIG. 1 when utilizing the above-described data transmission function to perform data transmission processing. On the operation screen illustrated in FIG. 2, a transmission destination 201 button, a data transmission protocol 202 button, a reading setting 203 button, a file type 204 button, a division setting 205 button, and a history call 206 button are displayed. On this operation screen, the settings corresponding to the respective buttons are input.

For example, the transmission destination 201 is a file transmission destination (in FIG. 2, AAA@Company.com and MyServer@Company.com have been input). The data transmission protocol 202 can designate electronic mail (E-mail), facsimile transmission (Fax), and file transfer (File). The reading setting 203 button can designate the resolution during document reading.

The file type 204 button used during data transmission can designate a file format, such as PDF and TIFF. The division setting 205 button can designate which mode is used to divide the file during file division. The history call 206 button calls a transmission history when images have been transmitted in the past.

Thus, a setting value corresponding to the respective buttons is input by the user. Then, when a start key (not illustrated) included in the operation unit 105 is pressed, a transmission request including the setting value set by the buttons 201 to 205 is input from the operation unit 105 into the control unit 102. The division setting 205 and the history call 206 will be described in more detail below.

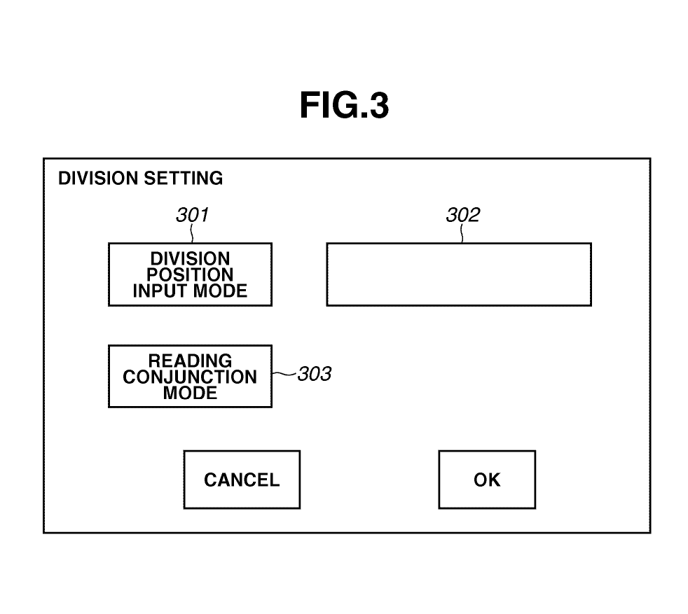

FIG. 3 illustrates an example of a division setting screen during file division displayed on the operation unit 105 illustrated in FIG. 1. The division setting screen illustrated in FIG. 3 is displayed when the division setting 205 button in FIG. 2 is pressed.

A button 301 is used to set a mode in which the user inputs the division position of the file before instructing the document to be read (hereinafter, referred to as a “division position input mode”).

An area 302 is for inputting a page number of the document as a division position where the document is to be divided. The area 302 can be input when the division position input mode has been selected. For example, if the user inputs “1-2, 3-4, 5” in the area 302, a file including an image of pages 1 to 2, a file including an image of pages 3 to 4, and a file including an image of page 5 of the document set in the sheet feeding mechanism in the scanner unit 104 are generated. Further, the respective files are transmitted together to the same designated transmission destination 201.

A button 303 is used to set a mode in which the division position is designated in conjunction with the reading of the document (hereinafter, referred to as a “reading conjunction mode”). When the button 303 is selected to start the scan reading, one file is generated from the single page or the plurality of pages obtained by reading the bundle of documents set in the sheet feeding mechanism in the scanner unit 104.

In the present exemplary embodiment, the following description will be based on an example in which the digital multifunction peripheral 100 is operated in either the division position input mode or the reading conjunction mode by selecting one of these modes. However, some other mode may also be employed. For example, all of the pages in a read document may be transmitted together in one file, a file may be transmitted for each page, or the file may be divided based on a rule determined in advance by the digital multifunction peripheral.

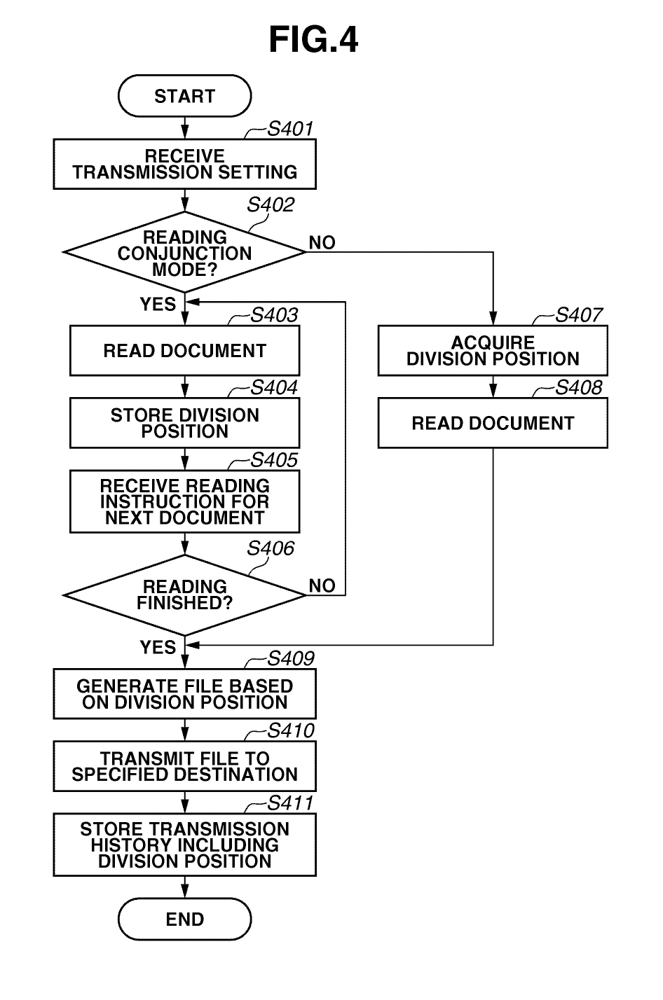

FIG. 4 is a flowchart illustrating a data transmission processing procedure in the digital multifunction peripheral 100 according to the present exemplary embodiment. Each step in FIG. 4 is executed by the CPU 108 in the control unit 102 based on a program stored in the memory 109.

The flowchart of FIG. 4 starts when the user presses a start key (not illustrated) in the operation unit 105.

In step S401, the CPU 108 receives a data transmission instruction input by the user from the operation unit 105. The received transmission instruction includes a file name of the image data to be transmitted, the transmission destination 201, the data transmission protocol 202, the reading setting 203, the file type 204, and the division setting 205.

In step S402, the CPU 108 determines whether the division setting 205 included in the transmission instruction received in step S401 indicates the division position input mode or the reading conjunction mode. If it is determined that the transmission instruction indicates the reading conjunction mode (YES in step S402), the processing proceeds to step S403. If it is determined that the transmission instruction indicates the division position input mode (NO in step S402), the processing proceeds to step S407.

In step S403, the scanner unit 104 generates image data by reading the set document based on an instruction from the CPU 108. If the set document has a plurality of pages, the number of pages measured by taking one of the pages in the read document as 1 page is stored in the memory 109.

In step S404, the scanner unit 104 stores, in the memory 109, the number of pages measured in step S403 and the number of times of a document-bundle reading operation when that number of pages was read in an associated manner. For example, a document consisting of 9 pages (sheets) may be divided into three document bundles of pages 1 to 3, pages 4 to 6, and pages 7 to 9. When these three document bundles are separately set in the ADF in three stages and a reading instruction is issued, the number of times of the document-bundle reading operation when the number of pages measured in step S403 is 1, 2, and 3 is 1. When the number of pages measured in step S403 is 4, 5, and 6, the number of times of the document-bundle reading operation is 2. When the number of pages measured in step S403 is 7, 8, and 9, the number of times of the document-bundle reading operation is 3. Thus, the measured number of pages and the number of times of the document-bundle reading operation are associated and stored for subsequent use in order to determine where to divide the file when dividing and filing the image data.

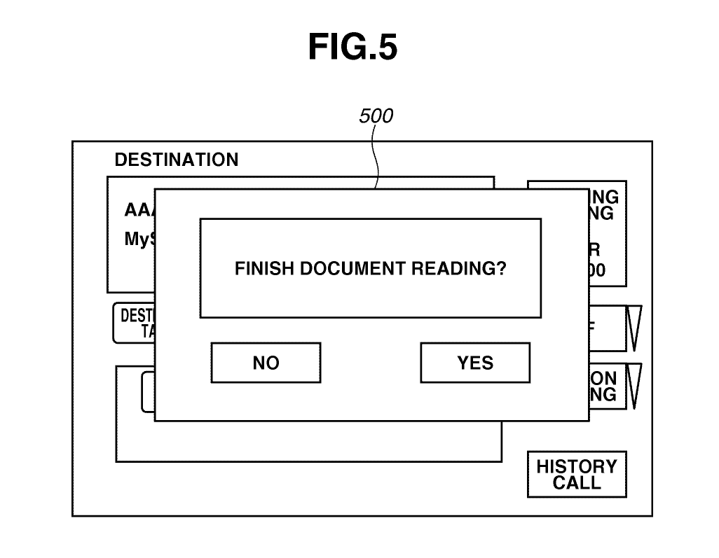

In step S405, the operation unit 105 displays the confirmation screen illustrated in FIG. 5, and waits for an instruction from the user.

FIG. 5 illustrates an example of the screen displayed by the operation unit 105 in step S405. On a confirmation screen 500, the user can issue an instruction to finish reading of the document by pressing a “YES” button. On the other hand, if the user presses a “NO” button, the user can instruct reading of the document to continue. If instructing to continue document reading, the user presses the “NO” button in FIG. 5 after setting the document to be read next in the scanner unit 104.

In step S406, the CPU 108 determines whether document reading is to finish or is to continue based on the instruction received in step S405. If it is determined that document reading is to finish (YES in step S406), the processing proceeds to step S409. If it is determined that document reading is to continue (NO in step S406), the processing returns to step S403, and the processing for reading the document set in the scanner unit 104 is again performed.

When operating in the reading conjunction mode, since the file is divided at each set document bundle, the time and effort required by the user to pre-check the correct number of pages in the file that acts as a file division unit is reduced.

Step S407 is processing that is performed if it is determined in step S402 that the transmission instruction indicates the division position input mode. In step S407, the CPU 108 acquires the division setting 205 included in the transmission instruction received in step S401, and stores information about the number of pages for dividing the file as a division position in the memory 109.

In step S408, the scanner unit 104 generates image data by reading the set document based on an instruction from the CPU 108.

When operating in the division position input mode, since the division position of the file is designated before issuing the transmission instruction, unlike when operating in the reading conjunction mode, the user does not have to set the next document again. Consequently, once the instruction has been transmitted, the digital multifunction peripheral 100 subsequently automatically executes the processing from document scanning to file transmission, which enables the user's time and effort relating to file division to be reduced.

In step S409, the CPU 108 converts the generated image data into image data of the file type 204 included in the transmission instruction, and divides the image data based on the division position stored in step S404 or step S407. Then, the CPU 108 stores the divided image data in the memory 109 as one file.

For example, if a document consisting of 9 pages (sheets) is divided into three document bundles of pages 1 to 3, pages 4 to 6, and pages 7 to 9, and these three document bundles are separately set in the ADF in three stages and a reading instruction is issued, the file is divided so that the image data for page numbers 1, 2, and 3 is a first file, the image data for page numbers 4, 5, and 6 is a second file, and the image data for page numbers 7, 8, and 9 is a third file.

In the present exemplary embodiment, after all of the document reading has finished, in step S409, the CPU 108 performs file division processing. However, the image data can also be filed immediately after a once-set document bundle has been read (i.e., during steps S402 to S406). By doing this, the processing for dividing the image data into a plurality of files can be omitted. Further, the filing does not have to be performed after all of the image data has been stored in the memory, so that the memory can be managed efficiently.

In addition, the image data reading processing and the filing processing may be performed in parallel. For example, the filing processing of the image data generated from the first document bundle can be performed in parallel with the processing for generating the image data from the second document bundle (step S403). By doing this, the series of processes from document reading to filing can be performed faster.

In step S410, based on an instruction from the CPU 108, the transmission interface 107 reads the divided files, which are divided into a plurality of files in step S409, from the memory 109, and transmits the divided files to the destination included in the transmission instruction.

In step S411, the CPU 108 stores the settings of items 201 to 205 included in the transmission instruction received in step S401 as a transmission history in the memory 109. In addition, the CPU 108 also associates information about the number of pages stored in step S404 or S407 as a file division position with the settings of items 201 to 205, and stores such data as a transmission history in the memory 109.

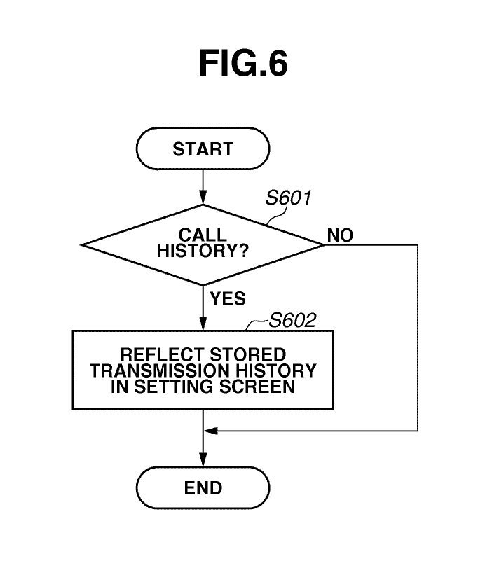

FIG. 6 is a flowchart illustrating the calling of the transmission history stored in step S411 of FIG. 4 and the setting of the data transmission processing. Each step in FIG. 6 is executed by the CPU 108 in the control unit 102 based on a program stored in the memory 109.

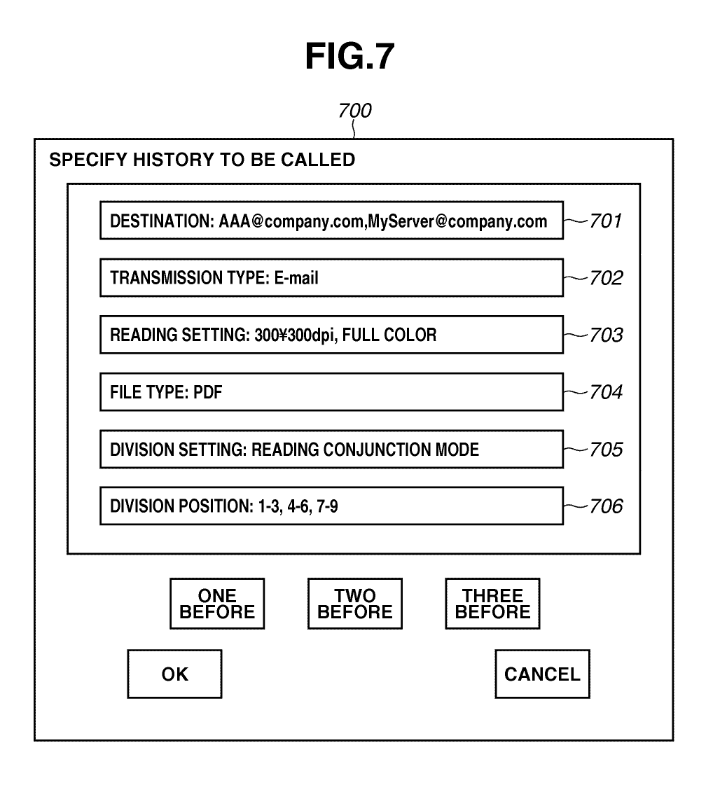

In step S601, the CPU 108 determines whether to call the transmission history based on whether the history call 206 button on the operation screen illustrated in FIG. 2 is pressed by the user. If it is detected that the history call 206 button is pressed by the user (YES in step S601), based on an instruction from the CPU 108, the operation unit 105 displays a history call screen illustrated in FIG. 7.

The history call screen 700 illustrated in FIG. 7 displays a transmission destination history 701, a data transmission protocol history 702, a reading setting history 703, a file type history 704, a division setting history 705, and a division position information history 706. These pieces of information are the transmission history stored in the memory 109 in step S411. Especially, in the present exemplary embodiment, when the division setting history 705 indicates the reading conjunction mode, the division position information history 706 was not input by the user, but rather was obtained by the CPU 108 automatically measuring the file division position.

In the history call screen 700 illustrated in FIG. 7, if an “OK” button is pressed when a specific transmission history is displayed, in step S602, the CPU 108 reflects the transmission history stored in the memory 109 in the setting screen of the operation unit 105, and finishes the processing of this flowchart.

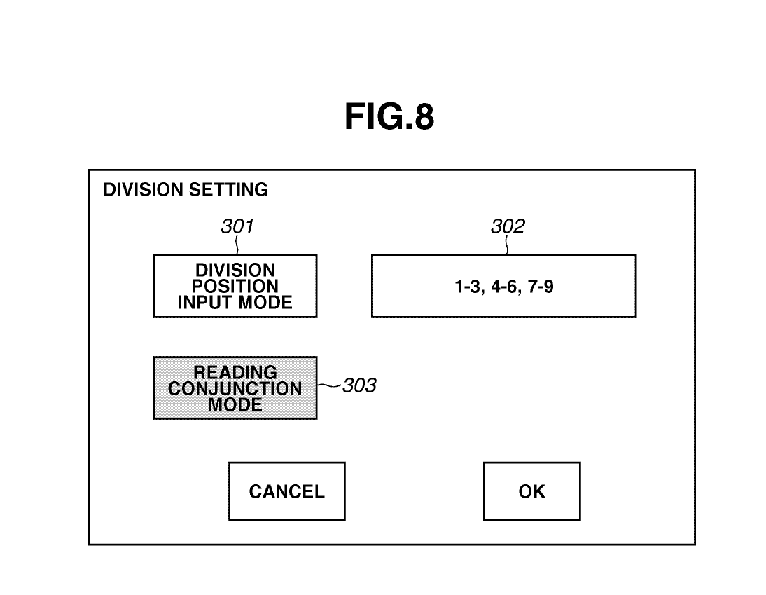

A division setting screen illustrated in FIG. 8 is a screen in which the transmission history was reflected in step S602. In the present exemplary embodiment, a history of division and transmission in the reading conjunction mode is read as a transmission history. In the division setting screen illustrated in FIG. 8, the reading conjunction mode is selected as a division setting. In addition, the division positions stored as a transmission history are automatically displayed on the operation screen as an initial value in the area 302.

When a transmission instruction is issued by pressing the start key in the state displayed by the screen in FIG. 8, the operation is performed in the reading conjunction mode. On the other hand, when the user presses the button 301 for selecting division position input mode in the state displayed by the division setting screen in FIG. 8, the division setting changes from operating in the reading conjunction mode to the division position input mode. Thus, the operation is performed in the division position input mode, in which the image is divided at the division positions (“1-3, 4-6, 7-9”) displayed in area 302.

According to the present exemplary embodiment, when a file is transmitted by dividing it, the division position is stored as a part of the transmission history, enabling data to be again transmitted with the same transmission setting.

Especially, when a file is transmitted by dividing it in the reading conjunction mode, the file is divided at each document bundle that was set at a time in the scanner unit 104. At this point, the number of pages in the document set at a time is measured and stored. When the transmission history of the data transmission processing executed in the reading conjunction mode is called, the division position of the file is reflected and displayed in the area 302 of the division position input mode in the operation screen. If the user wants to use the transmission destination, the transmission type, the reading setting, the file type, and the division setting stored as this transmission history as is, the user can issue a transmission instruction without making any changes.

On the other hand, the user can also use the transmission destination, the transmission type, the reading setting, and the file type stored as this transmission history as is, and just change the division setting from the reading conjunction mode to the division position input mode. In such a case, the division position to be input in the division position input mode is input as an initial value. Therefore, for example, when the user wants to file the same document again, utilizing this initial value allows the time and effort required to re-input the division position to be skipped. This allows the user's time and effort to be reduced when the user wants to scan the same document (or a document in the same format) a second or subsequent time and transmit the data. More specifically, simply by changing from the reading conjunction mode to the division position input mode after the transmission history has been called, the time and effort required to check the division position of the document and the time and effort required to set the document in the ADF again and again can be omitted.

When calling a transmission history that includes the division position of a document and newly performing data transmission processing, exactly the same document as the previously set document may be set, or a different document to the previously set document may be set.

The document to be newly set may be different from the previously set document. For example, the document to be newly set may be a document in which only apart of the previously set document has been replaced, a document that has the same total number of pages as the previously set document, or a document which has the same format as the previously set document.

In the present exemplary embodiment, as an example of the image reading apparatus, an example was described in which image data acquired by reading with the scanner unit 104 is transmitted to a designated transmission destination. However, as another example of the image reading apparatus, the present exemplary embodiment can also be applied by, instead of transmitting to a designated transmission destination, performing data storage processing to store a file in a storage area of the memory 109 specified as a designated storage location, or a storage area such as an external storage medium.

In the reading conjunction mode according to the present exemplary embodiment, an example was described in which a document is set in the ADF of the scanner unit 104, and image data is filed for each document bundle set in that ADF. However, the present exemplary embodiment can also be applied based on a reading conjunction mode which, instead of setting the document in the ADF, files image data each time a document placed on a platen glass is read.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2010-261596 filed Nov. 24, 2010, which is hereby incorporated by reference herein in its entirety.

What is claimed is:

1. An image reading apparatus, comprising:
a scan unit configured to obtain image data by reading a document;
a generation unit configured to, based on the image data obtained by the scan unit reading each bundle of a document having a plurality of pages which is divided into a plurality of bundles, generate a plurality of files corresponding to each of the plurality of bundles;
a first storage unit configured to store a division position for dividing the document into a plurality of bundles based on the reading of the document by the scan unit for each bundle; and
a control unit configured to, when the document having a plurality of pages is read by the scan unit, control the generation unit to generate a plurality of files from the image data obtained by the scan unit reading the document having a plurality of pages based on the division position stored in the first storage unit.

2. The image reading apparatus according to claim 1, further comprising a transmission unit configured to transmit the generated files to a designated transmission destination.

3. The image reading apparatus according to claim 1, further comprising a second storage unit configured to store the generated files in a specified storage area of a storage device based on a designated storage location.

4. The image reading apparatus according to claim 1, wherein the scan unit includes an auto document feeder (ADF) configured to read bundles of a document having a plurality of pages.

5. A method for controlling an image reading apparatus, the method comprising:
obtaining image data by reading a document with a scan unit;
generating, based on the image data obtained by reading each bundle of a document having a plurality of pages which is divided into a plurality of bundles, a plurality of files corresponding to each of the plurality of bundles;
storing a division position for dividing the document into a plurality of bundles based on the reading of the document for each bundle;
generating, when the document having a plurality of pages is read by the scan unit, a plurality of files from the image data obtained by reading the document having a plurality of pages based on the stored division position.

6. A computer-readable storage medium storing a program for causing an image reading apparatus to execute the method according to claim 5.
